(19) United States
(12) Patent Application Publication
(10) Pub. No.: US 2013/0182328 A1
(43) Pub. Date: Jul. 18, 2013

(54) Structured Smudge-Resistant Anti-Reflective Coatings and Methods of Making and Using the Same

(71) Applicants: Matthew Stewart, Somerville, MA (US); Joseph M. McLellan, Quincy, MA (US); Graciela B. Blanchet, Boston, MA (US); Brian T. Mayers, Arlington, MA (US); Adam Winkleman, Brookline, MA (US); Sandip Agarwal, Medford, MA (US); George M. Whitesides, Newton, MA (US)

(72) Inventors: Matthew Stewart, Somerville, MA (US); Joseph M. McLellan, Quincy, MA (US); Graciela B. Blanchet, Boston, MA (US); Brian T. Mayers, Arlington, MA (US); Adam Winkleman, Brookline, MA (US); Sandip Agarwal, Medford, MA (US); George M. Whitesides, Newton, MA (US)

(73) Assignee: Nano Terra Inc., Brighton, MA (US)

(21) Appl. No.: 13/515,145

(22) PCT Filed: Dec. 10, 2010
(86) PCT No.: PCT/US10/59895

§ 371 Date: Mar. 11, 2013

Related U.S. Application Data
(60) Provisional application No. 61/285,426, filed on Dec. 10, 2009.

(51) Int. Cl. G02B 1/11

(52) U.S. Cl. CPC G02B 1/11; Y10S 977/902; B82Y 20/00
USPC 359/580; 428/156; 428/172; 428/141; 977/902

(57) ABSTRACT

The present invention is directed to articles comprising smudge-resistant anti-reflective surfaces, and products and devices comprising the articles.

### BACKGROUND OF THE INVENTION

1. Field of the Invention

The present invention is directed to anti-reflective, smudge-resistant articles having structured surfaces, and products and devices comprising the articles.

2. Background

Touch panels that are manipulated by contact with a finger or pen are increasingly used in automatic teller machines, personal data assistants, smart phones, tablet PCs, and the like. The performance, lifetime, and appearance of touch panels can be limited by the ability to resist abrasions, scratches, and the accumulation of smudges and the like. Many display screens include transparent, rigid thermosetting polymers that are impact resistant, but unfortunately, are also susceptible to abrasions and scratches. Protection from abrasions and scratches can be provided by, e.g., a transparent hard-coat. However, most smooth transparent surfaces are susceptible to smudging and can also be highly reflective. Thus, in addition to scratch and/or abrasion resistance, what is further needed is a layer suitable for preventing the accumulation of oils, grease, fingerprints, sebum, sweat, cosmetics, and other ambient materials on a display screen.

Furthermore, display devices are used extensively in offices, homes and outdoors, where ambient light reflected on a display can deteriorate the image quality and make it difficult to view the display screen. Ambient light reflected from a display device can also cause visual fatigue and other health problems. Therefore, an antireflection film suitable for a wide range of wavelengths is highly desirable.

### BRIEF SUMMARY OF THE INVENTION

What is needed is a distortion-free coating that can be utilized with display devices to provide smudge resistance, abrasion resistance, and anti-reflective properties. The present invention is directed to articles having both anti-reflective and anti-smudge functionality. The articles of the present invention are suitable for applying to a wide variety of display devices, either as an integrated layer or as a removable surface layer, and are suitable for use with all manner of display devices to protect the display screens against smudges while at the same time reducing light reflected from the display screens.

The anti-reflective and smudge-resistant articles can be used in electronic device applications, appliances, industrial building and architectural applications, health care applications, as well as the decorative arts. The smudge-resistant surfaces and coatings of the present invention can be prepared efficiently utilizing low-cost fabrication methods.

Whereas previous anti-smudge coatings have attempted to disguise the presence of smudges on optical surfaces by refractive index modulation, the coatings and layers of the present invention provide a significant advance by preventing the accumulation of smudges. Moreover, the coatings and layers of the present invention can be used on optically transmissive surfaces without image distortion.

The present invention is directed to a smudge-resistant, anti-reflective article comprising front and back surfaces, the front surface comprising a grid protruding from about 40% or less of the front surface of the article, wherein 70% or more of light normally incident to the back surface of the article having a wavelength of 400 nm to 750 nm is transmitted through the article, and wherein 80% or more of the transmitted light is refracted by about 10° or less.

In some embodiments, the grid has a height, width and spacing such that a human finger placed in contact with the article has a contact area with the front surface of the article that is reduced by at least 80% compared to an article lacking the grid.

In some embodiments, the grid comprises a plurality of openings having a shape selected from triangles, squares, rectangles, pentagons, hexagons, octagons, circles, ovals, and combinations thereof.

In some embodiments, grid has a height of about 5 μm to about 100 μm, a lateral dimension of about 5 μm to about 100 μm, and a pitch or spacing of about 100 μm to about 500 μm. In some embodiments, a grid has a height of about 40 μm to about 80 μm, a lateral dimension of about 20 μm to about 80 μm, and a pitch or spacing of about 100 μm to about 400 μm.

The present invention is also directed to a smudge-resistant, anti-reflective article comprising front and back surfaces, the front surface comprising a plurality of protrusions covering about 20% or less of the front surface of the article, the protrusions having a lateral dimension greater than 50 μm to about 150 μm, a height of about 25 μm to about 300 μm, and a spacing of about 50 μm to about 300 μm, wherein 70% or more of light normally incident to the back surface of the article having a wavelength of 400 nm to 750 nm is transmitted through the article, and wherein 80% or more of the transmitted light is refracted by about 10° or less.

In some embodiments, the plurality of protrusions have a three-dimensional shape selected from: a cylinder, a trigonal post, a rectilinear post, a pentagonal post, a hexagonal post, an octagonal post, a trigonal pyramid, a square pyramid, a cone, a spike, a cross, a hollow variant thereof, and combinations thereof.

In some embodiments, the grid or plurality of protrusions has sidewalls that are smooth, angled, beveled, corrugated, tiered, roughened, or a combination thereof.

In some embodiments, at least an outer surface of the grid or the plurality of protrusions has a surface free energy of about 50 mN/m or less.

In some embodiments, an article of the present invention further comprises a coating on at least a portion of the grid or plurality of protrusions.

In some embodiments, the coating is an anti-reflective coating that is present on at least a portion of the grid or plurality of protrusions, and optionally present on the front surface of the article, the anti-reflective coating comprising a bottom layer and a top layer, each layer having a transmission of about 90% or higher at a wavelength of 400 nm to 800 nm, wherein the bottom layer has a first refractive index and the top layer has a refractive index that is about 10% to about 90% less than the refractive index of the bottom layer, and one or more gradient layers are optionally present between the bottom layer and the top layer, wherein each optional gradient layer has a refractive index that is at least 10% less than a refractive index of an immediate underlying layer.

In some embodiments, the coating is an anti-reflective coating that is present on at least a portion of the grid or plurality of protrusions, and optionally present on the front surface of the article, the anti-reflective coating comprising a plurality of layers, each layer having a transmission of about 90% or higher at a wavelength of 400 nm to 800 nm, and each layer having a thickness of about 100 nm to about 200 nm, wherein adjacent layers in the anti-reflective coating differ in refractive index by about 10% or more.

In some embodiments, the coating is an anti-reflective coating that is present on at least a portion of the grid or plurality of protrusions, and optionally present on the front surface of the article, the anti-reflective coating comprising a plurality of nanoscale protrusions extending from the surface, wherein the nanoscale protrusions include a pointed end portion and have a height of about 100 nm to about 5,000 nm and a lateral dimension of about 100 nm to about 3,000 nm.

In some embodiments, the front surface of the article is substantially smooth. In some embodiments, the front surface of the article is roughened.

In some embodiments, 80% or more of light normally incident to the back surface of the article having a wavelength of 400 nm to 750 nm is transmitted through the article.

In some embodiments, the article comprises a material selected from: quartz, alumina, aluminum oxynitride, magnesium aluminate spinel, silica, borosilicate glass, indium tin oxide, a polycarbonate, high-density polyethylene, a nylon, a polyurethane, a polyacrylate, a poly(alkyl methacrylate), a polyethylene terephthalate, a composite thereof, and combinations thereof.

The present invention is also directed to a product comprising a smudge-resistant, anti-reflective article as described herein. Products include, but are not limited to, a window, a display device, a communications device, a photograph, and a lens. In some embodiments, a product is a display device having the smudge-resistant, anti-reflective article applied to an outer surface, and the display device transmits light normally incident to the back surface of the substrate.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 provides an optical microscopy image of an article of the present invention comprising a hexagonal grid that protrudes from a front surface of the article.

FIG. 2 provides a scanning electron microscope image of an article of the present invention comprising a randomized hexagonal grid that protrudes from a front surface of the article.

FIGS. 3A-3C provide optical microscopy images of articles of the present invention comprising a square grid, a grating, and a plurality of square post protrusions, respectively.

FIGS. 4A-4B provide optical microscopy images of articles of the present invention comprising a plurality of cross-shaped protrusions and a plurality of hollow cylindrical post-shaped protrusions, respectively.

FIG. 5 provides an optical microscopy image of an article of the present invention comprising a plurality of tiered cylindrical protrusions.

FIGS. 6A-6B provide scanning electron microscopy images of an article of the present invention comprising a grid protruding from a front surface of the article.

FIGS. 7A-7B provide optical microscopy images of articles of the present invention comprising hexagonal grids without and with hard-coat layers thereon, respectively, after abrasion testing.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “some embodiments,” “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above,” “below,” “up,” “down,” “top,” “bottom,” etc.) made herein are for purposes of description and illustration only, and should be interpreted as non-limiting upon the articles, surfaces, substrates, coatings, methods, and products of any method of the present invention, which can be spatially arranged in any orientation or manner.

The articles of the present invention are smudge-resistant. As used herein, a “smudge” refers to a residue that can be deposited on a surface, and can include, but is not limited to, dirt, a particulate (e.g., diesel exhaust, soot, and the like), an oil (e.g., a composition that is immiscible with water), a vapor (e.g., water and steam, as well as environmental vapors such as fog, clouds, smog, exhaled air, and the like), a component of human and/or animal perspiration (e.g., an exudate from the apocrine glands, merocrine glands, sebaceous glands, and the like), oils produced by the hair and/or skin of human and/or animal, other biological compositions (e.g., saliva, blood, skin flakes, hair, excrement, other waste, and the like), and combinations thereof.

Not being bound by any particular theory, the refractive index of smudges is typically different than that of a film material. Thus, in addition to any light-blocking debris present in the smudge, this difference in refractive index between the smudge and the underlying substrate makes the smudge visible to a viewer, and can give a smudge an “oily” appearance, especially when deposited onto a smooth surface.

The articles of the present invention are not particularly limited by size, shape, or geometry, and can be planar, non-planar or multi-planar, curved, and/or flexible, and thus the articles can be applied to a display device of arbitrary shape and size.

In some embodiments, an anti-reflective, smudge-resistant article of the present invention has a front and/or back surface area of about 1 mm² to about 10 m², about 1 cm² to about 5 m², about 10 cm² to about 1 m². In addition, a front surface of an article of the present invention can be substantially smooth or roughened, without limitation.

The articles of the present invention are not limited by composition and can generally include any material that is substantially transparent to visible light (i.e., comprising one or more wavelengths of about 400 nm to about 750 nm). Materials suitable for use in the articles of the present invention include, but are not limited to, oxides of silicon (e.g., quartz, undoped silica glass, fluorinated silica glass, borosilicate glass, borophosphorosilicate glass, organosilicate glass, porous organosilicate glass, and the like), oxides of aluminum (e.g., alumina, aluminum oxynitride, magnesium aluminate spinel, and the like), transparent conducting oxides (e.g., zinc oxide, indium tin oxide, doped variants thereof, and the like), polymers and plastics (e.g., polyolefins such as high-density polyethylene, polystyrenes, and the like, polycarbonate, nylons, polyurethanes, polyacrylates, poly(alkyl methacrylate), cellulosic polymers, polyamides, polyimides, polyphenylenes, polyesters, polyethylene terephthalate, and the like), composites thereof, laminates thereof, and combinations thereof.

The present invention is directed to an article comprising front and back surfaces, the front surface comprising a grid protruding from about 40% or less of the front surface of the article, wherein 70% or more of light normally incident to the back surface of the article having a wavelength of 400 nm to 750 nm is transmitted through the article, and wherein 80% or more of the transmitted light is refracted by about 10° or less.

In some embodiments, an article comprises a grid that protrudes from about 40% or less of the front surface of the article. As used herein, “protrudes from about 40% or less of the front surface” refers to a percentage of the surface area of the front surface on which a grid is formed. For example, in embodiments in which a grid is formed by, e.g., an additive process, about 40% or less of the surface area of the front surface of an article is “masked” by the protruding portion of a grid.

In some embodiments, an article of the present invention comprises a grid that protrudes from (i.e., covers) about 40% or less, about 35% or less, about 30% or less, about 25% or less, about 20% or less, about 15% or less, or about 10% or less of the surface area of the front surface of an article. In some embodiments, an article of the present invention comprises a grid that protrudes from (i.e., covers) about 5% to about 40%, about 10% to about 40%, about 10% to about 30%, about 15% to about 40%, about 15% to about 30%, about 20% to about 40%, out 20% to about 30%, about 25% to about 40%, or about 30% to about 40% of the surface area of the front surface of an article.

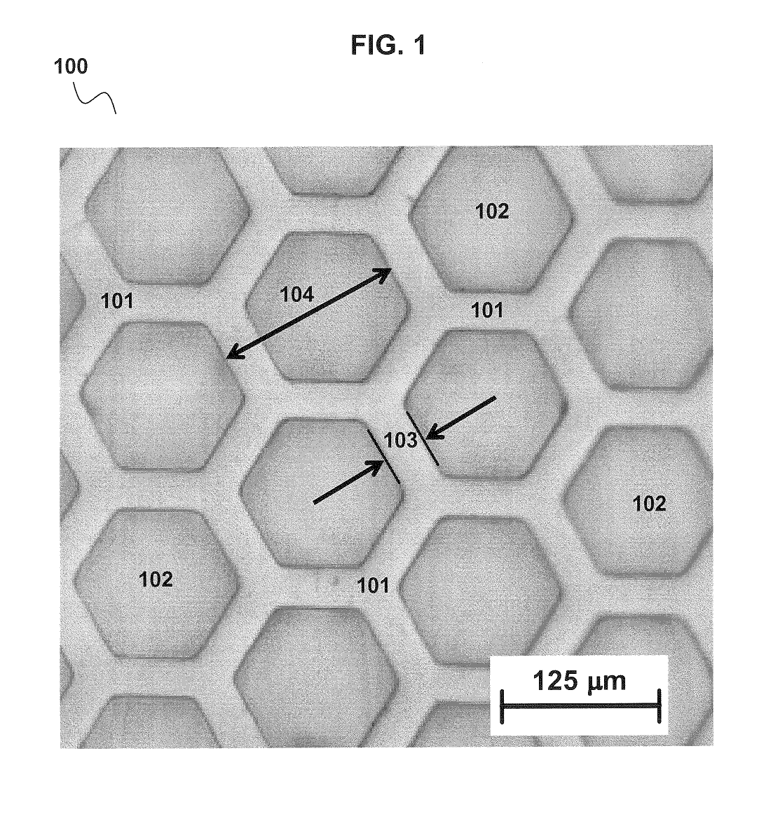

In some embodiments, the articles of the present invention comprise a grid protruding from the front surface, which refers to a pattern formed by a series of raised, interlocking lines. FIG. 1 provides an optical microscope image, 100, of an article of the present invention comprising a grid, 101, which covers a portion of the front surface, 102. Referring to FIG. 1, the protruding hexagonal grid, 101, has a width, 103, and a pitch or spacing, 104. For the article of FIG. 1, the protruding hexagonal grid, 101, covers about 35% of the area of the front surface, 102.

A grid can comprise straight, curved, or randomly oriented protruding lines that form a pattern on a front surface of an article. Thus, a grid can form a pattern comprising a plurality of openings having a shape selected from triangles, squares, rectangles, pentagons, hexagons, octagons, circles, ovals, and combinations thereof. The edges of the openings can be substantially straight (as provided in the article of FIG. 1), or alternatively can include wavy, zigzag, or any other random or periodic shape.

The grids have a cross-sectional shape that can be rectilinear (e.g., square, rectangular, and the like), trapezoidal (e.g., having sidewalls that form an outside angle of about 40° to about 130° with the front surface of the article), pointed (and having, e.g., straight, convex or concave sides), curved (e.g., having a cross-sectional shape corresponding to about 10° to about 200° of an arc having a spherical, ellipsoidal, or oval shape), tiered (e.g., a ziggurat shape having two to ten levels), or combinations thereof (e.g., a rectilinear or trapezoidal shape having a pointed surface, tiered trapezoids having sloped sidewalls, a tiered rectilinear shape having a pointed top surface, and the like). In some embodiments, the profile of the grid includes one, two, three, or more channels therein such that a cross-section of the grid is partially hollow.

The present invention is directed to a smudge-resistant, anti-reflective article comprising front and back surfaces, the front surface comprising a plurality of protrusions covering about 40% or less of the front surface of the article, the protrusions having a lateral dimension of about 40 μm to about 150 urn, a height of about 25 μm to about 300 μm, and a spacing of about 50 μm to about 600 μm, wherein 70% or more of light normally incident to the back surface of the article having a wavelength of 400 nm to 750 nm is transmitted through the article, and wherein 80% or more of the transmitted light is refracted by about 10° or less.

In some embodiments, the front surface comprises a plurality of protrusions extending from about 20% or less of the front surface of the article, the protrusions having a lateral dimension greater than 50 μm to about 150 μm, a height of about 25 μm to about 300 μm, and a spacing of about 50 μm to about 300 μm.

The present invention is also directed to a smudge-resistant, anti-reflective article comprising front and back surfaces, the front surface comprising a plurality of protrusions covering about 20% or less of the front surface of the article, the protrusions having a lateral dimension greater than 50 μm to about 150 μm, a height of about 25 μm to about 300 μm, and a spacing of about 50 μm to about 300 μm, wherein 70% or more of light normally incident to the back surface of the article having a wavelength of 400 nm to 750 nm is transmitted through the article, and wherein 80% or more of the transmitted light is refracted by about 10° or less.

In some embodiments, an article comprises a plurality of protrusions that cover about 20% or less, about 15% or less, about 12% or less, or about 10% or less of the surface area of the front surface of an article. In some embodiments, an article comprises a plurality of protrusions that cover about 8% to about 20%, about 10% to about 20%, about 10% to about 17.5%, about 12% to about 20%, about 12% to about 17.5%, about 15% to about 20%, about 12.5%, about 15%, about 17.5%, or about 20% of the surface area of the front surface of an article.

The protrusions can have virtually any three-dimensional shape so long as the shape can be stably formed on a front surface of an article. Shapes for protrusions include, but are not limited to, posts (e.g., cylinders, trigonal posts, rectilinear posts, pentagonal posts, hexagonal posts, octagonal posts, and the like), polygons, (e.g., three-dimensional trapezoids, rectilinear polygons, and the like having sidewalls that form an outer angle with the front surface of about 40° to about 140°), pyramids (e.g., trigonal pyramids, square pyramids, and the like), cones (e.g., having sidewalls that form an outer angle with the front surface of about 40° to about 140°), spikes, crosses (e.g., three-, four, five-, six-, seven, eight-, nine-, or ten-armed crosses), hollow variants thereof, and combinations thereof.

The protrusions have a lateral dimension that is the magnitude of a cross-section of the protrusions (which can be, e.g., length, width, radius, diameter, and the like) at the front surface of the article. Generally, the lateral dimension(s) of a protrusion define the area a protrusion occupies on a front surface of an article. The protrusions can also be described by their height, and can have a height of about 25 μm to about 300 μm, about 30 μm to about 250 μm, about 35 μm to about 200 μm, about 40 μm to about 175 μm, about 45 μm to about 150 μm, about 50 μm to about 125 μm, about 50 μm to about 100 μm, about 55 μm to about 90 μm, or about 60 μm to about 80 μm.

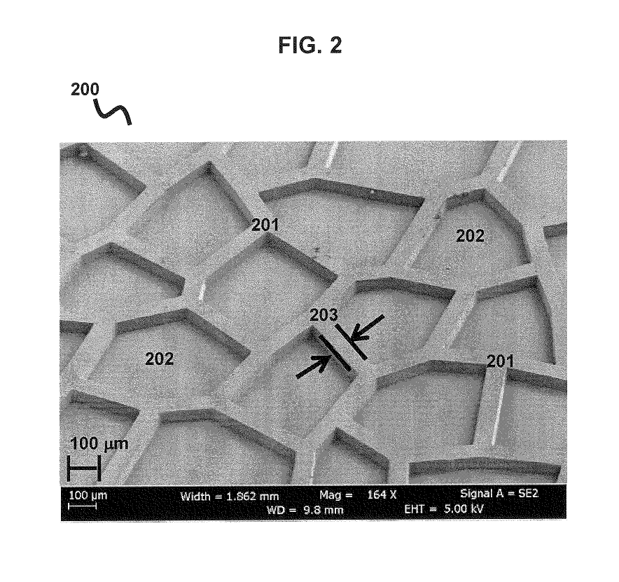

In some embodiments, a plurality of protrusions form a pattern having a sinusoidal, parabolic, rectilinear, or saw tooth profile. The plurality of protrusions can be spatially arranged in any manner on the substrate including symmetric (ordered) arrangements, asymmetric arrangements, and random arrangements. As an example, FIG. 2 provides an optical microscope image, 200, of an article of the present invention comprising a grid of random arrangement, 201, which covers a portion of the front surface, 202. The grid has a width of about 63 μm, 203, and a height of about 45 μm. For the article of FIG. 2, the protruding grid of random arrangement, 201, comprises a hexagonal grid where the six vertices of the hexagons are randomly displaced. The geometry was computed by assuming a hexagonal grid with 500 μm pitch and using a computer algorithm to randomly displace the six vertices of the hexagons in the X/Y plane by +/−50-100 μm. In some embodiments, the plurality of protrusions comprises a rectilinear pattern, a pentagonal pattern, a hexagonal pattern, and the like.

In some embodiments, a plurality of protrusions form a grid. In some embodiments, the grid is a polygonal grid. In some embodiments, the polygonal grid comprises one or more polygons selecting from: triangles, squares, pentagons, hexagons, heptagons, octagons, and the like, and combinations thereof. In some embodiments, the polygons are regular. In some embodiments, the polygons are irregular. In some embodiments, the polygons are arranged symmetrically. In some embodiments, the polygons are arranged asymmetrically. In some embodiments, the polygons are arranged randomly. In some embodiments, the grid is a hexagonal grid. In some embodiments, the hexagonal grid has a height of about 50 μm to about 65 μm, a lateral dimension of about 40 μm to about 60 μm, and a spacing of about 400 μm to about 600 μm.

In some embodiments, a plurality of protrusions form posts. In some embodiments, the posts have a height of about 50 μm to about 65 μm, a lateral dimension of about 40 μm to about 60 μm, and a spacing of about 100 μm to about 200 μm.

The sidewalls of a grid or plurality of protrusions can be smooth, angled, beveled, corrugated, tiered, roughened, or a combination thereof.

Materials suitable for use in the grids and protrusions include, but are not limited to, the materials listed above for use with the articles of the present invention. In preferred embodiments, the grids and protrusions comprise a material that is at least partially optically transparent in the visible region of the spectrum. In some embodiments, a grid or protrusion has an optical transparency of about 50% or more, about 60% or more, about 70% or more, or about 80% or more.

The articles of the present invention can be prepared by additive or subtractive methods. For example, in some embodiments an article of the present invention is prepared by etching away a portion of an article to provide a patterned surface comprising a grid or plurality of protrusions. Etching methods suitable for use with the present invention include those known to persons of ordinary skill in the electronic device arts, as well as the etching methods described in U.S. application Ser. Nos. 11/950,703, 12/189,485, 12/237,754, 12/483,128, and 61/165,755, each of which is incorporated herein by reference in its entirety.

In some embodiments, materials for use as grids or protrusions comprise polymers and/or polymer precursors suitable for spin-coating, dip-coating, spray-coating, flow-coating, or pouring onto a surface, followed by embossing or imprinting to provide a grid or plurality of protrusions. For example, forming can comprise applying a moldable material to a surface, contacting a patterned master with the coated surface, and hardening the moldable material (by, e.g., heating, exposing to UV light, and the like) to provide a grid or plurality of protrusions corresponding to the pattern in the tool. Alternatively, forming can comprise applying a moldable material to a patterned master, contacting the coated master with a surface, transferring the moldable material to the surface, and hardening the moldable material (in which the moldable material is hardened before or after removing the master). Additional suitable deposition, molding, embossing, imprinting and forming methods are disclosed in U.S. Pat. No. 6,355,198, which is incorporated herein by reference in its entirety.

In some embodiments, a front surface of an article not covered by a grid or plurality of protrusions is free from a material used to provide the grid or plurality of protrusions. For example, an imprint lithography process in which a stamp conformal contacts a surface can be used to provide such an article. Alternatively, a front surface of an article not covered by a grid or plurality of protrusions can comprise a layer of the material used to provide the grid or plurality of protrusions. Thus, in some embodiments the grid or plurality of protrusions forms a discrete, continuous layer on the front surface of an article.

In some embodiments, at least a portion of a grid or plurality of protrusions is anchored in (i.e., penetrate into) a surface of an article. In some embodiments, a grid or plurality of protrusions penetrate about 10 μm to about 100 μm into a surface of an article. Not being bound by any particular theory, anchoring of a grid or protrusions can provide enhanced abrasion resistance.

In some embodiments, a grid or plurality of protrusions comprises an elastomer such as, but not limited to, polydimethylsiloxane, polysilsesquioxane, polyisoprene, polybutadiene, polychloroprene, acryloxy elastomers, fluorinated and perfluorinated polymers (e.g., polytetrafluoroethylene, perfluoroalkoxy polymer, fluorinate ethylene propylene, and the like), and combinations thereof.

Additional non-limiting examples of polymers suitable for use with the present invention include, by way of illustration only, polyolefins (e.g., polyethylene, poly(isobutene), poly(isoprene), poly(4-methyl-1-pentene), polypropylene, ethylene-propylene copolymers, ethylene-propylene-hexadiene copolymers, and the like); ethylene-vinyl acetate copolymers; styrene polymers (e.g., poly(styrene), poly(2-methylstyrene), styrene-acrylonitrile copolymers having less than about 20 mole-percent acrylonitrile, styrene-2,2,3,3,-tetrafluoropropyl methacrylate copolymers, and the like); halogenated hydrocarbon polymers (e.g., poly(chloro-trifluoroethylene), chlorotrifluoroethylene-tetrafluoroethylene copolymers, poly(hexa-fluoropropylene), poly(tetrafluoroethylene), tetrafluoroethylene-ethylene copolymers, poly(vinyl fluoride), poly(trifluoroethylene), poly(vinylidene fluoride), and the like); vinyl polymers (e.g., poly(vinylbutyrate), poly(vinyldecanoate), poly(vinylhexanoate), poly(vinylpropionate), poly(vinyldodecanoate), poly(vinylhexadecanoate), poly(heptafluoro-iso-propoxyethylene), 1-heptafluoro-iso-propoxymethylethylene-maleic acid copolymers, poly(vinyloctanoate), poly(heptafluoro-iso-propoxypropylene), poly(methacrylonitrile), poly(vinylalcohol), poly(vinylbutyral), poly(ethoxyethylene), poly(methoxyethylene), poly(vinylformal), and the like); acrylic polymers (e.g., poly(n-butylacetate), poly(ethylacrylate), poly[(1-chlorodifluoromethyl)tetrafluoroethyl acrylate], poly[di-(chlorofluoromethyl)fluoromethyl acrylate], poly(1,1-dihydroheptafluorobutyl acrylate), poly(1,1-dihydropenta-fluoro-iso-propyl acrylate), poly(1,1-dihydropentadecafluorooctyl acrylate), poly(hepta-fluoro-iso-propyl acrylate), poly[5-(heptafluoro-iso-propoxy)pentyl acrylate], poly[1]-(heptafluoro-iso-propoxy)undecyl acrylate], poly[2-(heptafluoropropoxy) ethyl acrylate], and poly(nonafluoro-iso-butyl acrylate), and the like); methacrylic polymers (e.g., poly(benzyl methacrylate), poly(n-butyl methacrylate), poly(iso-butyl methacrylate), poly(tert-butyl methacrylate), poly(tert-butylaminoethyl methacrylate), poly(dodecyl methacrylate), poly(ethyl methacrylate), poly(2-ethylhexyl methacrylate), poly(n-hexyl methacrylate), poly(dimethylaminoethyl methacrylate), poly(hydroxyethyl methacrylate), poly(phenyl methacrylate), poly(n-propyl methacrylate), poly(octadecyl methacrylate), poly(1,1-dihydropentadecafluorooctyl methacrylate), poly(heptafluoro-iso-propyl methacrylate), poly(heptadecafluorooctyl methacrylate), poly(1-hydrotetrafluoroethyl methacrylate), poly(1-hydrohexafluoroisopropyl methacrylate), poly(1,1-dihydrotetrafluoropropyl methacrylate), and poly(tert-nonafluorobutyl methacrylate); polyethers (e.g., poly(chloral), poly(oxybutene)diol, poly(oxyisobutene)diol, poly(oxydecamethylene), poly(oxyethylene)dimethyl ether polymers having molecular weights of about 1,500 Da or less, poly(oxyhexamethylene)diol, poly(oxypropylene)diol, poly(oxypropylene)-dimethylether, poly(oxytetramethylene), and the like); polyether copolymers (e.g., poly(oxyethylene)-poly(oxypropylene)-poly(oxyethylene) block copolymers, oxyethylene-oxypropylene copolymers having about 20 mol-% or more of oxypropylene, oxytetra-methylene-oxypropylene copolymers, block copolymers having oxyethylene-oxypropylene copolymer blocks separated by a poly(oxydimethylsilylene) block, and the like); polyamides (e.g., poly[imino(1-oxodecamethylene)], poly[imino(1-oxotetramethylene)] or nylon 4, poly[imino(1-oxododecamethylene)] or nylon 12, poly[imino(1-oxohexamethylene)] or nylon 6, poly(iminosuberoyliminooctamethylene), poly(iminoazelaoyliminononamethylene), poly(iminosebacoyliminodecamethylene), and the like); polyimines (e.g., poly[(benzoylimino)ethylene], poly[(butyrylimino)ethylene], poly[(dodecanoylimino)ethylene], poly[(hexanoylimino)ethylene], poly[(heptanoylimino)ethylene], (dodecanoylimino)ethylene-(acetyleimino)-trimethylene copolymers, poly[(pentanoylimino)ethylene], poly{[(3-methyl)butyrylimino]ethylene}, poly[(pentadecafluorooctadecanoylimino)ethylene], and the like); polyurethanes (e.g., copolymers of methylenediphenyl di-iso-cyanate and butanediol, copolymers of poly(oxytetramethylene)diol, copolymers of hexamethylene di-iso-cyanate and triethylene glycol, copolymers of 4-methyl-1,3-phenylene di-iso-cyanate and tripropylene glycol, and the like); polysiloxanes, e.g., poly(oxydimethylsilylene), poly(oxymethylphenylsilylene), and the like; cellulosic polymers (e.g., amylose, amylopectin, cellulose acetate butyrate, ethylcellulose, hemicellulose, nitrocellulose, and the like), and combinations thereof.

In some embodiments, a grid or a plurality of protrusions comprises a composition comprising a polymer and a material selected from: a particulate, a nanotube, a nanofiber, and combinations thereof. As used herein, a particulate refers to a composition of discrete particles. Particles can have virtually any three-dimensional shape, and in some embodiments have a cross-sectional dimension (e.g., a diameter, length, width, and the like) of about 10 nm to about 10 μm, about 50 nm to about 5 μm, or about 100 nm to about 1 μm. Particulates can include nanoparticles, core-shell particles, functionalized particles, and the like.

As used herein, a nanotube refers to an elongated rod, platelet, cylinder, and the like. As used herein a nanofiber refers to an elongated structure having an aspect ratio (length:width) greater than that of a nanotube. Nanotube and nanofibers for use with the present invention include structures having a width of about 10 nm to about 50 μm, and an aspect ratio of at least 2:1.

Materials suitable for use in particulates, nanotubes, and nanofibers include, but are not limited to, metals, metal oxides (e.g., silica, alumina, titania, zinc oxide, and the like), polymers, ceramics, carbon, and the like, and combinations thereof. In some embodiments, a particulate, nanotube and/or nanofiber is present in a material used to form a grid or a plurality of protrusions in a concentration of about 0.1% to about 20%, about 0.5% to about 15%, or about 1% to about 10% by weight.

In some embodiments, a grid or a plurality of protrusions comprises a material having a glass transition temperature or a Vicat softening point (i.e., a “Vicat hardness”, which as used herein is defined as the temperature at which a material is penetrated to a depth of 1 mm by a flat-ended needle with a 1 mm² circular or square cross-section applied to the material under a load of 9.81 N) of about 50° C. to about 250° C., about 75° C. to about 250° C., about 100° C. to about 250° C., about 125° C. to about 250° C., about 150° C. to about 250° C., about 50° C. to about 225° C., about 50° C. to about 200° C., about 50° C. to about 175° C., or about 50° C. to about 150° C. Non-limiting exemplary materials suitable for use as in a grid or a plurality of protrusions include: polyethylene terephthalate having a T_{g} of about 70° C.; polyvinyl alcohol having a T_{g} of about 85° C.; polyvinylchloride having a T_{g} of about 80° C.; polystyrene having a T_{g} of about 95° C.; atactic polymethylmethacrylate having a Tₛ of about 105° C.; and polycarbonate having a Tₛ of about 145° C.

In some embodiments, a grid or a plurality of protrusions has a refractive index (n) of about 1.1 to about 2.2, about 1.2 to about 2.2, about 1.3 to about 2.2, about 1.4 to about 2.2, about 1.5 to about 2.2, about 1.2 to about 2.0, about 1.3 to about 1.9, about 1.4 to about 1.8, about 1.3, about 1.35, about 1.4, about 1.45, about 1.5, about 1.55, about 1.6, or about 1.7. In some embodiments, a grid or a plurality of protrusions has a refractive index not more than 20% greater, not more than 10% greater, about equal to, or less (e.g., 10% less, 20% less, 30% less, 40% less, or 50% less) than a refractive index of the substrate.

The smudge-resistant, anti-reflective articles of the present invention provide significant benefits over previous anti-smudge systems because instead of hiding smudges by controlling refractive index, the grids and patterns of protrusions have a height, width and spacing that physically prevents a human finger from transferring oil and other contaminants to a portion of a the front surface of the articles. Specifically, in some embodiments a human finger placed in contact with the article has a contact area with the front surface of the article that is reduced by at least 80%, at least 85%, at least 90%, or at least 95% compared to an article lacking the grid or plurality of protrusions. Thus, the articles of the present invention are of a dimension such that the contact area between a finger (or other human skin surface) and the front surface of the article is physically reduced, thereby preventing smudges from accumulating on a front surface of the articles.

In some embodiments, a grid has a height of about 5 μm to about 100 μm, a width of about 5 μm to about 100 μm, and a pitch or spacing of about 100 μm to about 500 μm. In some embodiments, a grid has a height of about 40 μm to about 80 μm, a width of about 20 μm to about 80 μm, and a pitch or spacing of about 100 μm to about 400 μm.

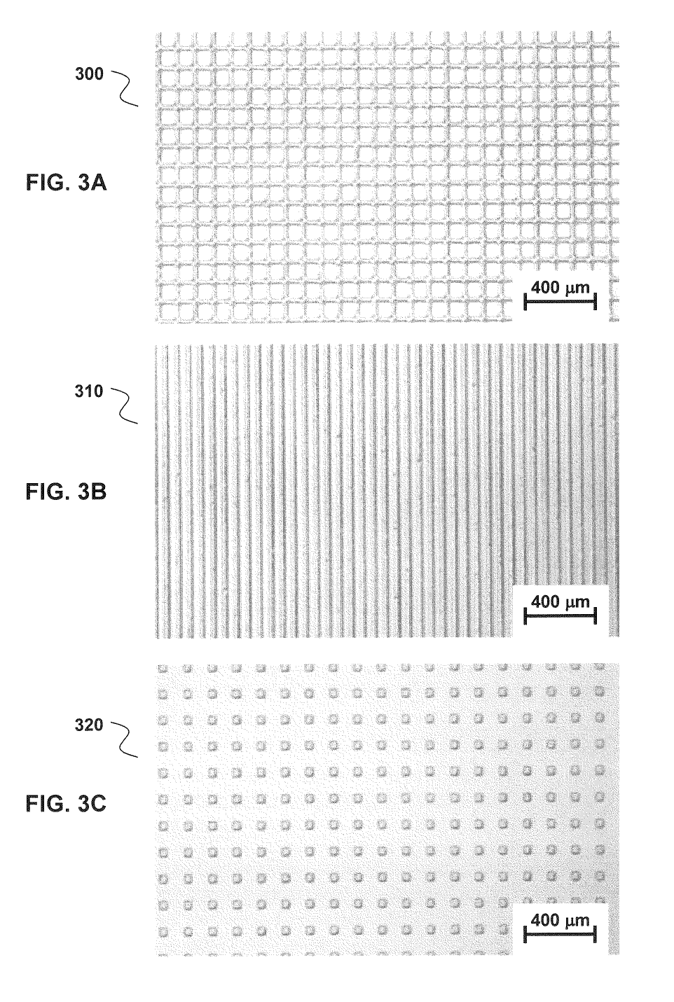

FIGS. 3A-3C provide optical microscope images, 300, 310 and 320, respectively, of articles comprising grids, gratings, and a plurality of protrusions according to the present invention. Referring to FIG. 3A, an image, 300, of an article comprising a grid having a rectilinear shape is provided. The grid has a width of about 28 μm, a height of about 10 μm, and a pitch or spacing of about 100 μm. Referring to FIG. 3B, an image, 310, of an article comprising a grating having a width of about 32 μm and a pitch or spacing of about 65 μm is provided. Referring to FIG. 3C, an image, 320, of an article comprising a plurality of square protrusions having a lateral dimension of about 43 μm, a height of about 10 μm, and a pitch or spacing of about 135 μm.

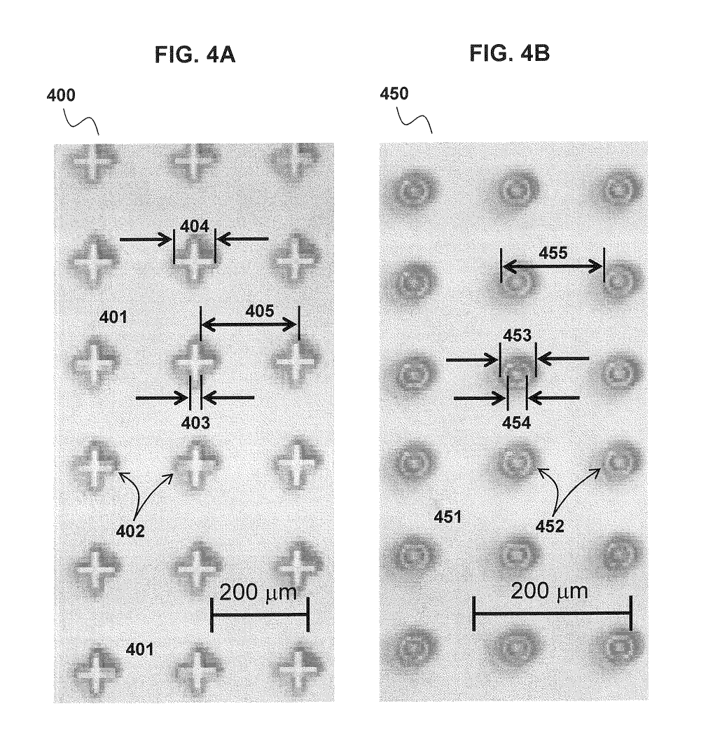

FIGS. 4A-4B provide optical microscope images, 400 and 450, respectively, of articles comprising a plurality of protrusions according to the present invention. Referring to FIG. 4A, an image, 400, of an article having a front surface, 401, comprising a plurality of cross-shaped protrusions, 402, having a width, 403, of about 20 μm, a second lateral dimension, 404, of about 94 μm, a height of about 37 μm, and a pitch or spacing, 405, of about 242 μM. Referring to FIG. 4B, an image, 450, of an article having a front surface, 451, comprising a plurality of hollow cylindrical protrusions, 452, having an exterior diameter, 453, of about 33 μm, an interior diameter, 454, of about 24 μm, a height of about 37 μm, and a pitch or spacing, 455, of about 120 μm.

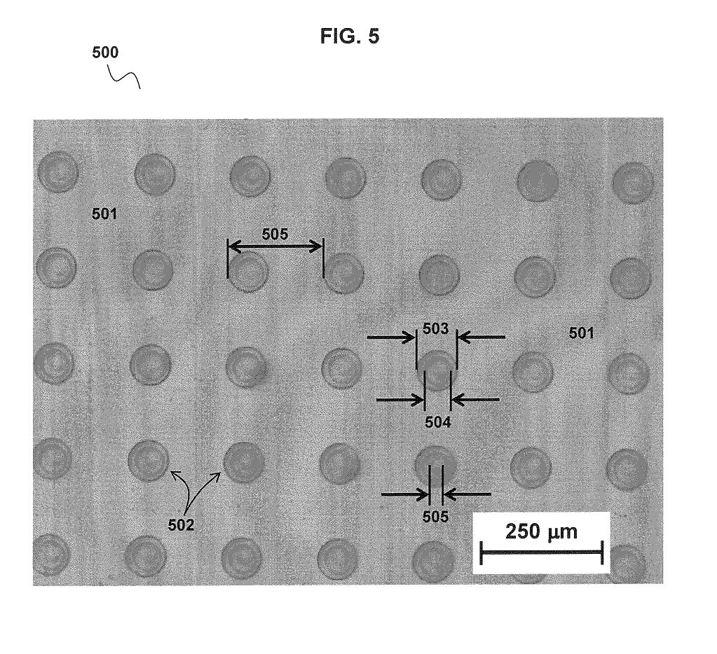

FIG. 5 provides an optical microscope image, 500, of an article comprising a plurality of protrusions according to the present invention. Referring to FIG. 5, an image, 500, of an article having a front surface, 501, comprising a plurality of tiered cylindrical protrusions, 502, having a base width, 503, of about 80 μm, a second lateral dimension, 504, of about 62 μm, a third lateral dimension, 505, of about 48 μm, a height of about 80 μm, and a pitch or spacing, 505, of about 200 μm.

In addition to being of a size suitable for minimizing contact between a human finger and the front surface of the article, the grids and/or protrusions can have a surface free energy that also prevents smudges from being transferred onto the article. Thus, in some embodiments, at least an outer surface of a grid or plurality of protrusions has a surface free energy of about 50 mN/m or less, about 40 mN/m or less, about 30 mN/m or less, or about 20 mN/m or less.

The surface energy, reflectivity, hydrophobicity and/or functionality of any of: an outer surface of a grid or plurality of protrusions, or a front surface of an article can be intrinsic to the material from which the grid, protrusions, or a front surface of an article are prepared, or alternatively, can be controlled by the use of a coating layer. Thus, in some embodiments, an article comprises a coating layer applied to a front and/or back surface of an article, an outer surface of a grid and/or plurality of protrusions, or a combination thereof. A coating layer can be applied conformally to a grid or protrusions, applied selectively to an outer surface and/or the sidewalls of a grid or protrusions, or optionally applied to a front surface of an article.

In some embodiments, an anti-reflective coating layer is applied to a front and/or back surface of an article prior to forming a grid or plurality of protrusions on a front surface of the article, thereby foaming a composite article having both anti-smudge and anti-reflective properties. For example, an anti-reflective coating layer having a moth eye structure comprising a plurality of conical protrusions having widths of about 200 nm and heights of about 150 nm is applied to a substrate, and a plurality of protrusions or a grid is then applied thereto. The resulting article comprises a substantially planar front surface that includes the moth eye structure embedded therein. A further coating layer can then be applied to a portion of the grid or plurality of protrusions.

In some embodiments, a coating layer comprises a gradient refractive index (“GRIN”) structure that includes a bottom layer and a top layer, each layer having a transmission of about 90% or higher at a wavelength of 400 nm to 800 nm, wherein the bottom layer has a first refractive index and the top layer has a refractive index that is about 10% to about 90% less than the refractive index of the bottom layer, and one or more gradient layers are optionally present between the bottom layer and the top layer, wherein each optional gradient layer has a refractive index that is at least 10% less than a refractive index of an immediate underlying layer.

In some embodiments, a coating layer comprises a GRIN structure that includes a plurality of layers, each layer having a transmission of about 90% or higher at a wavelength of 400 nm to 800 nm, and each layer having a thickness of about 100 nm to about 200 nm, wherein adjacent layers in the anti-reflective coating differ in refractive index by about 10% or more. For example, in some embodiments a GRIN structure comprises at least a first layer that includes a material having a refractive index of 2.0 or greater, and at least a second layer that includes a material having a refractive index of less than 2.0, wherein the refractive index of the first and second layer differs by about 10% or more. In some embodiments, a GRIN structure comprises at least a first layer that includes a material selected from: titania, tantalum oxide, zirconia, niobium oxide, silicon nitride, and combinations thereof, and at least a second layer that includes a material selected from: silica (as well as doped and/or porous variants thereof), magnesium fluoride, and the like, and combinations thereof, wherein the refractive index of the first and second layer differs by about 10% or more.

A GRIN structure can be prepared by sequentially depositing materials having a controlled refractive index by processes known to persons of ordinary skill in the thin-film deposition arts such as, but not limited to, dip-coating, spray coating, flow-coating, vapor phase depositing, chemical vapor depositing, plasma-enhanced chemical vapor depositing, sol-gel coating, sputtering, and the like.

In some embodiments, a coating layer comprises a dielectric stack anti-reflective coating that includes alternating layers of high-refractive index (i.e., n≧2.0) and low-refractive index (i.e., n<2.0) materials. Suitable dielectric stack anti-reflective coatings can be deposited by a variety of processes known to persons of ordinary skill in the art such as, but not limited to, chemical vapor deposition, thermal deposition, and the like. In some embodiments, a dielectric stack anti-reflective coating includes 2-10 layers, 3-8 layers, or 4-6 layers, wherein each layer is about 100 nm to about 2,500 nm thick, about 100 nm to about 1,000 nm thick, about 100 nm to about 500 nm thick, or about 100 nm to about 200 nm thick. For example, a broadband visible wavelength anti-reflective coating can include a “quarter-half-quarter” design, in which several alternating high- and low-refractive index quarter-wave layers are covered by two quarter-wave (i.e., a single “half-wave”) high-refractive index layers, and the outer layer is a low-refractive index quarter wave layer.

In some embodiments, a coating layer comprises a plurality of nanoscale protrusions extending from the surface, wherein the nanoscale protrusions include a pointed end portion and have a height of about 100 nm to about 5,000 nm and a lateral dimension (i.e., width or diameter) of about 100 nm to about 3,000 nm. In some embodiments, a coating layer comprises a plurality of nanoscale protrusions extending from the surface, the nanoscale protrusions having conical shape with a height of about 100 nm to about 200 nm and a width of about 150 nm to about 250 nm. In some embodiments, the nanoscale protrusions comprise a plurality of cones, spikes, pyramids, and the like, having a height of about 200 nm to about 2,000 nm and a lateral dimension of about 200 nm to about 1,000 nm. In some preferred embodiments, the nanoscale protrusions have an aspect ratio (height:width) of about 1.5:1 to about 4:1, about 2:1 to about 3.5:1, about 2:1, about 2.5:1, or about 3:1. Materials suitable for use in a coating layer comprising a plurality of nanoscale protrusions include those polymers listed herein, as well as fluorinated and/or perfluorinated variants thereof. In some embodiments, a coating layer comprising a plurality of nanoscale protrusions comprises a polymer such as, but not limited to, an acrylate, a polyurethane, an epoxy, a polycarbonate, a polysiloxane, a poly(alkylsiloxane), a fluorinated and/or perfluorinated variant thereof, or a combination thereof. In some embodiments, a coating layer comprising a plurality of nanoscale protrusions includes a plurality of nanoparticles dispersed therein, the nanoparticles being of a diameter suitable for inclusion in the coating layer.

In some embodiments, a coating layer further comprises an additional low-surface energy coating thereon, which as used herein refers to a coating suitable for providing a surface having a surface energy of about 50 mN/m or less. Specifically, in some preferred embodiments a coating layer comprising a plurality of nanoscale protrusions extending from the surface comprises a low-surface energy coating. The low-surface energy coating can be applied conformally to the nanoscale protrusions (e.g., at a thickness of about 20 nm to about 100 μm), as a planarizing layer surrounding the nanoscale protrusions (e.g., at depth equivalent to the height of the nanoscale protrusions), or as a planarizing layer surrounding and covering the nanoscale protrusions (e.g., at a depth greater than the height of the nanoscale protrusions).

In some embodiments, a low-surface energy coating is a planarizing layer having a total thickness about 1.1 to about 5 times greater, about 1.2 to about 4 times greater, about 1.3 to about 3 times greater, about 1.4 to about 2 times greater, or about 1.5 times greater than the height of the nanoscale protrusions.

Low-surface energy coatings suitable for use with the present invention include, but are not limited to, polytetrafluoroethylene, amorphous polymer resins (e.g., TEFLON® AF, E.I. DuPont de Nemours Corp., Wilmington, Del.), perfluoropolyether, perfluoroalkoxy polymers, fluorinated ethylene propylene, ethylene tetrafluoroethylene, polyvinyl fluoride, ethylene chlorotrifluoroethylene, polyvinylidene fluoride, and the like, porous variants thereof, block co-polymers thereof, sol-gel materials comprising fluorinated precursors, hybrid organic-inorganic materials comprising Si—F and/or C—F bonds, and combinations thereof.

In some embodiments, a coating for use with the present invention is functionalized or derivatized with a moiety to impart hydrophobicity to the coating. In some embodiments, a coating comprises a functional group selected from: an optionally substituted C₁-C₃₀ alkyl, an optionally substituted C₂-C₃₀ alkenyl, an optionally substituted C₂-C₃₀ alkynyl, an optionally substituted C₆-C₃₀ aryl, an optionally substituted C₆-C₃₀ aralkyl, an optionally substituted C₆-C₃₀ heteroaryl, and combinations thereof, wherein these groups can be linear or branched. Optional substituents for hydrophobic coatings include, but are not limited to, halo and perhalo (i.e., wherein halo is any one of: fluorine, chlorine, bromine, iodine, and combinations thereof), alkylsilyl, alkoxy, siloxyl, tertiary amino, and combinations thereof.

In some embodiments, an optionally substituted hydrophobic coating comprises a C₁-C₃₀ fluoroalkyl, a C₁-C₃₀ perfluoroalkyl, or a combination thereof.

As used herein, “alkyl,” by itself or as part of another group, refers to straight, branched and cyclic hydrocarbons of up to 30 carbon atoms, such as, but not limited to, octyl, decyl, dodecyl, hexadecyl, and octadecyl.

As used herein, “alkenyl,” by itself or as part of another group, refers to a straight, branched and cyclic hydrocarbons of up to 30 carbon atoms that includes at least one carbon-carbon double bond (in either the cis or trans configuration), such as, but not limited to, 2-octenyl, 1-dodecenyl, 1-8-hexadecenyl, 8-hexadecenyl, and 1-octadecenyl.

As used herein, “alkynyl,” by itself or as part of another group, refers to straight, branched and cyclic hydrocarbons of up to 30 carbon atoms that include at least one carbon-carbon triple bond, such as, but not limited to, 1-octynyl and 2-dodecynyl.

As used herein, “aryl,” by itself or as part of another group, refers to cyclic, fused cyclic and multi-cyclic aromatic hydrocarbons containing up to 30 carbons in the ring portion, such as, but not limited to, phenyl, naphthyl, anthracenyl, fluorenyl, tetracenyl, perylenyl, coronenyl, and the like.

As used herein, “aralkyl” or “arylalkyl,” by itself or as part of another group, refers to alkyl groups as defined above having at least one aryl substituent, such as benzyl, phenylethyl, and 2-naphthylmethyl. Similarly, the term “alkylaryl,” as used herein by itself or as part of another group, refers to an aryl group, as defined above, having an alkyl substituent, as defined above.

As used herein, “heteroaryl,” by itself or as part of another group, refers to cyclic, fused cyclic and multicyclic aromatic groups containing up to 30 atoms in the ring portions, wherein the atoms in the ring(s), in addition to carbon, include at least one heteroatom. The term “heteroatom” is used herein to mean an oxygen atom (“O”), a sulfur atom (“S”) or a nitrogen atom (“N”). Additionally, the term heteroaryl also includes N-oxides of heteroaryl species that containing a nitrogen atom in the ring. Typical examples include pyrrolyl, pyridyl, pyridyl N-oxide, thiophenyl, and furanyl.

As used herein, “alkylsilyl,” by itself or as part of another group, refers to an (—Si(R)ₓH_{y}) moiety, wherein 1≦x≦3 and y=3−x, and wherein R is independently an optionally fluorinated, linear or branched C₁-C₈ alkyl, alkenyl, or alkynyl.

As used herein, “alkoxy,” by itself or as part of another group, refers to a (—OR) moiety, wherein R is selected from alkyl, alkenyl, alkynyl, aryl, aralkyl, and heteroaryl groups described above.

As used herein, “siloxyl,” by itself or as part of another group, refers to a (—Si(OR)ₓR¹_{y}) moiety, wherein 1≦x≦3 and y=3−x, wherein R and R¹ are independently selected from hydrogen and the alkyl, alkenyl, alkynyl, aryl, aralkyl, and heteroaryl groups described above.

As used herein, “tertiary amino,” by itself or as part of another group, refers to an (—NRR¹) moiety, wherein R and R¹ are independently an optionally fluorinated, linear or branched C₁-C₈ alkyl, alkenyl, or alkynyl group.

In some embodiments, a hydrophobic coating for use with the present invention comprises a plurality of Si—F, C—F, Si—CH₃ and/or Si—CH₂—Si bonds. In some embodiments, a coating for use with the present invention comprises a plurality of Si—F or C—F bonds. A fluorinated coating can be applied from a precursor, e.g., via vapor deposition, masked deposition, spraying, spin-coating, and the like. Alternatively, an article having a grid or a plurality of protrusions thereon can be fluorinated by exposure to, e.g., F₂, SiF₄, SF₆, HF, SELECTFLUOR® (Air Products and Chemicals, Inc., Allentown, Pa.), a fluorinated alkyl and/or alkoxy silane, and the like, as well as other fluorination methods that would be apparent to a person of ordinary skill in the art of surface fluorination.

The smudge-resistant, anti-reflective articles of the present invention provide additional significant benefits over previous anti-smudge, anti-reflective systems because 50% or more of light normally incident to a back surface of the article having a wavelength of 400 nm to 750 nm is transmitted through the article, and 80% or more of the transmitted light is refracted by about 10° or less. Thus, the articles of the present invention can be applied to virtually any display device to provide a smudge-free, distortion-free and haze-free view for a user. In some embodiments, 60% or more, 70% or more, 80% or more, 90% or more, or 95% or more of light normally incident to a back surface of the article having a wavelength of 400 nm to 750 nm is transmitted through the article. Furthermore, in some embodiments 85% or more, 90% or more, or 95% or more of the transmitted light is refracted by about 10° or less.

The present invention is also directed to products comprising the smudge-resistant and anti-reflective articles. Products include, but are not limited to, windows, minors, optical elements (e.g., optical elements for use in eyeglasses, cameras, binoculars, telescopes, and the like), lenses (e.g., Fresnel lenses, etc.), watch crystals, hologram displays, cathode ray tube display devices, optical filters, data storage devices (e.g., compact discs, DVD discs, CD-ROM discs, and the like), flat panel electronic displays (e.g., LCDs, plasma displays, LED displays, OLED displays, and the like), touch-screen displays (e.g., computer touch screens, personal data assistants, smart phones, tablet PCs, e-books, and the like), solar cells, flexible electronic displays (e.g., electronic paper and books), cellular phones, global positioning systems, calculators, graphic articles (e.g., signage), aircraft displays, avionics, motor vehicles (e.g., wind screens, windows, mirrors, displays, interior cabin surfaces, and the like), artwork (e.g., sculptures, paintings, lithographs, and the like), membrane switches, jewelry and other decorative articles, and combinations thereof.

In some embodiments, a product is selected from: a window, a display device, a communications device, a photograph, and a lens. In some embodiments, a product is a display device having the smudge-resistant, anti-reflective article applied to an outer surface, wherein the display device transmits light normally incident to the back surface of the substrate.

The smudge-resistant, anti-reflective articles of the present invention can be formed on a device as an integrated coating layer (e.g., bonded to a display device), or alternatively, can be provided as a stand alone layer that can be reversibly or irreversibly applied to a device by a manufacturer, a retailer and/or a consumer.

In preferred embodiments, an article of the present invention is substantially transparent to visible light and can be applied over a substrate comprising an integrated light-emitting device. As used herein, “substantially transparent to visible light” refers to 50% or more, 60% or more, 70% or more, 80% or more, 90% or more, or 95% or more of light normally incident to the back surface of the article having a wavelength of 400 nm to 750 nm being transmitted through the article. For example, an article of the present invention can be applied to a display device comprising phosphor, a light-emitting diode, an organic light-emitting diode, a fluorophore, a chromophore, a back-light, and the like, and combinations thereof, wherein a coating of the present invention does not substantially distort an emitted image.

Having generally described the invention, a further understanding can be obtained by reference to the examples provided herein. These examples are given for purposes of illustration only and are not intended to be limiting.

### EXAMPLES

### Example 1

Articles comprising protruding square or hexagonal grids were prepared by drop-casting a UV-curable liquid (e.g., Norland Optical Adhesive 61) on a glass substrate and then patterning the UV-curable liquid by embossing or imprinting. The patterning comprised contacting with the coated surface a polydimethylsiloxane (PDMS) stamp having a patterned surface that comprised a square or hexagonal array of channels therein. Any air bubbles present in the drop-cast UV-curable were removed by degassing in a desiccator. The UV-curable liquid was then hardened by exposing the article to UV light through the backside of the glass substrate. After hardening, the PDMS stamp was removed from the substrate.

Articles comprising protruding hexagonal grids were prepared from a heat-softenable material using a similar procedure. Specifically, articles comprising grids were prepared by heating a polycarbonate film (0.015″ thickness, McMaster-Carr, Aurora, Ohio) to about 190° C., a patterned PDMS stamp was then pressed into the softened polycarbonate, the polycarbonate was cooled, and the PDMS stamp was removed.

The grid dimensions of the articles prepared by this process are summarized in the following Table.

TABLE
Articles comprising square and hexagonal grids were prepared
by the method of Example 1. In all cases the grids were formed
on glass substrates, except for the polycarbonate, which comprised
a polycarbonate grid embossed into a polycarbonate substrate.

| Shape | Grid Material | Width (μm) | Pitch (μm) | Height (μm) |
|---|---|---|---|---|
| Hexagonal | NOA 61^{a} | 20 | 400 | 10 |
| Hexagonal | NOA 61^{a} | 25 | 200 | 10 |
| Hexagonal | NOA 61^{a} | 25 | 400 | 10 |
| Hexagonal | NOA 61^{a} | 25 | 500 | 10 |
| Hexagonal | NOA 61^{a} | 30 | 300 | 10 |
| Hexagonal | NOA 61^{a} | 30 | 450 | 10 |
| Hexagonal | NOA 61^{a} | 40 | 550 | 10 |
| Hexagonal | NOA 61^{a} | 10 | 150 | 20 |
| Hexagonal | NOA 61^{a} | 10 | 250 | 20 |
| Hexagonal | NOA 61^{a} | 10 | 350 | 20 |
| Hexagonal | NOA 61^{a} | 10 | 450 | 20 |
| Hexagonal | NOA 61^{a} | 10 | 550 | 20 |
| Hexagonal | NOA 61^{a} | 15 | 150 | 20 |
| Hexagonal | NOA 61^{a} | 15 | 250 | 20 |
| Hexagonal | NOA 61^{a} | 15 | 350 | 20 |
| Hexagonal | NOA 61^{a} | 15 | 450 | 20 |
| Hexagonal | NOA 61^{a} | 15 | 550 | 20 |
| Hexagonal | NOA 61^{a} | 25 | 400 | 20 |
| Hexagonal | NOA 61^{a} | 25 | 500 | 20 |
| Hexagonal | NOA 61^{a} | 30 | 450 | 20 |
| Hexagonal | NOA 61^{a} | 40 | 500 | 20 |
| Hexagonal | NOA 61^{a} | 20 | 150 | 40 |
| Hexagonal | NOA 61^{a} | 20 | 200 | 40 |
| Hexagonal | NOA 61^{a} | 20 | 250 | 40 |
| Hexagonal | NOA 61^{a} | 20 | 300 | 40 |
| Hexagonal | NOA 61^{a} | 20 | 400 | 40 |
| Hexagonal | NOA 61^{a} | 25 | 200 | 40 |
| Hexagonal | NOA 61^{a} | 25 | 250 | 40 |
| Hexagonal | NOA 61^{a} | 25 | 300 | 40 |
| Hexagonal | NOA 61^{a} | 25 | 400 | 40 |
| Hexagonal | NOA 61^{a} | 25 | 500 | 40 |
| Hexagonal | NOA 61^{a} | 30 | 250 | 40 |
| Hexagonal | NOA 61^{a} | 30 | 300 | 40 |
| Hexagonal | NOA 61^{a} | 30 | 350 | 40 |
| Hexagonal | NOA 61^{a} | 30 | 450 | 40 |
| Hexagonal | NOA 61^{a} | 30 | 550 | 40 |
| Hexagonal | NOA 61^{a} | 40 | 350 | 40 |
| Hexagonal | NOA 61^{a} | 40 | 400 | 40 |
| Hexagonal | NOA 61^{a} | 40 | 450 | 40 |
| Hexagonal | NOA 61^{a} | 40 | 500 | 40 |
| Hexagonal | NOA 61^{a} | 40 | 550 | 40 |
| Hexagonal | NOA 61^{a} | 30 | 450 | 50 |
| Hexagonal | NOA 61^{a} | 30 | 550 | 50 |
| Hexagonal | NOA 61^{a} | 40 | 500 | 50 |
| Hexagonal | NOA 61^{a} | 40 | 550 | 50 |
| Hexagonal | ST-3080^{b} | 20 | 150 | 25-30 |
| Hexagonal | ST-3080^{b} | 20 | 200 | 25-30 |
| Hexagonal | ST-3080^{b} | 20 | 250 | 25-30 |
| Hexagonal | ST-3080^{b} | 20 | 300 | 25-30 |
| Hexagonal | ST-3080^{b} | 20 | 400 | 25-30 |
| Hexagonal | ST-3080^{b} | 25 | 200 | 25-30 |
| Hexagonal | ST-3080^{b} | 25 | 250 | 25-30 |
| Hexagonal | ST-3080^{b} | 25 | 300 | 25-30 |
| Hexagonal | ST-3080^{b} | 25 | 400 | 25-30 |
| Hexagonal | ST-3080^{b} | 25 | 500 | 25-30 |
| Hexagonal | ST-3080^{b} | 30 | 250 | 25-30 |
| Hexagonal | ST-3080^{\b} | 30 | 300 | 25-30 |
| Hexagonal | ST-3080^{b} | 30 | 350 | 25-30 |
| Hexagonal | ST-3080^{b} | 30 | 550 | 25-30 |
| Hexagonal | ST-3080^{b} | 40 | 350 | 25-30 |
| Hexagonal | ST-3080^{b} | 40 | 400 | 25-30 |
| Hexagonal | ST-3080^{b} | 40 | 450 | 25-30 |
| Hexagonal | ST-3080^{b} | 40 | 500 | 25-30 |
| Hexagonal | ST-3080^{b} | 40 | 550 | 25-30 |
| Hexagonal | UVHC-8558c | 40 | 450 | 40 |
| Hexagonal | Polycarbonate^{d} | 30 | 450 | 40 |
| Hexagonal | Polycarbonate^{d} | 40 | 450 | 40 |
| Square | NOA 61^{a} | 10 | 100 | 10 |
| Square | NOA 61^{a} | 20 | 200 | 10 |
| Square | NOA 61^{a} | 25 | 115 | 10 |
| Square | NOA 61^{a} | 25 | 115 | 37 |
| Square | NOA 61^{a} | 25 | 115 | 58 |
| Square | NOA 61^{a} | 25 | 115 | 65 |
| Square | NOA 61^{a} | 25 | 242 | 10 |
| Square | NOA 61^{a} | 25 | 242 | 37 |
| Square | NOA 61^{a} | 25 | 242 | 58 |
| Square | NOA 61^{a} | 25 | 242 | 65 |
| Square | NOA 61^{a} | 25 | 550 | 10 |
| Square | NOA 61^{a} | 25 | 550 | 37 |
| Square | NOA 61^{a} | 25 | 550 | 58 |
| Square | NOA 61^{a} | 25 | 550 | 65 |
| Square | NOA 61^{a} | 25 | 1250 | 10 |
| Square | NOA 61^{a} | 25 | 1250 | 37 |
| Square | NOA 61^{a} | 25 | 1250 | 65 |
| Square | NOA 61^{a} | 40 | 875 | 10 |
| Square | NOA 61^{a} | 40 | 875 | 58 |
| Square | NOA 61^{a} | 50 | 230 | 37 |
| Square | NOA 61^{a} | 50 | 230 | 65 |
| Square | NOA 61^{a} | 50 | 480 | 37 |
| Square | NOA 61^{a} | 50 | 480 | 65 |
| Square | NOA 61^{a} | 110 | 500 | 37 |
| Square | NOA 61^{a} | 110 | 500 | 65 |

^{a}NOA-61 is Norland Optical Adhesive 61, a clear colorless, UV-curable (λ = 320-380 nm, max @ 365 nm) liquid photopolymer. The cured polymer has a refractive index of about 1.56 (Norland Products, Inc., Cranbury, NJ).
^{b}ST-3080 is a mixture of polyether polyols, di-(methylthio)toluenediamine, and phenyl mercuric neodecanoate (BJB Enterprises, Inc., Tustin, CA).
^{c}UVHC-8558 is a clear, 100% solids, UV-curable silicone hard coat resin (Momentive Performance Materials, Albany, NY).
^{d}Clear polycarbonate films, smooth on both sides (McMaster-Carr, Aurora, OH).

### Example 2

Articles comprising a plurality of cylindrical protrusions were prepared by drop-casting a UV-curable liquid (e.g., Norland Optical Adhesive 61) on a glass substrate and then patterning the UV-curable liquid by embossing or imprinting. The patterning comprised contacting the coated glass surface with a PDMS stamp having a patterned surface that comprised a plurality of cylindrical indentations therein. Any air bubbles present in the drop-cast UV-curable were removed by degassing in a desiccator. The UV-curable liquid was then hardened by exposing the article to UV light through the backside of the glass substrate. After hardening, the PDMS stamp was removed from the substrate. Articles comprising a plurality of cylindrical protrusions were also prepared using heat-curable liquids using the same procedure except that heat was applied to the articles during the hardening.

Articles comprising a plurality of protrusions were prepared using a heat-softenable material using a similar procedure. Specifically, articles comprising a plurality of protrusions were prepared by heating a polycarbonate film (0.015″ thickness, McMaster-Carr, Aurora, Ohio) to about 190° C., a patterned PDMS stamp was then pressed into the softened polycarbonate, the polycarbonate was cooled, and the PDMS stamp was removed.

The dimensions of the patterns of protrusions on the articles summarized in the following Table.

TABLE
The dimensions of patterns of cylindrical protrusions prepared by
the method of Example 2. In all cases the protrusions were formed
on glass substrates, except for the polycarbonate, which comprised
a polycarbonate grid embossed into a polycarbonate substrate.

| | Protrusion | | | |
|---|---|---|---|---|
| Shape | Material | Width (μm) | Pitch (μm) | Height (μm) |
| Cylindrical | NOA 61 | 25 | 75 | 37 |
| Cylindrical | NOA 61 | 25 | 75 | 65 |
| Cylindrical | NOA 61 | 40 | 50 | 65 |
| Cylindrical | NOA 61 | 40 | 120 | 37 |
| Cylindrical | NOA 61 | 40 | 120 | 65 |
| Cylindrical | ST-3080 | 40 | 120 | 65 |
| Cylindrical | UVHC-8558 | 40 | 120 | 65 |
| Cylindrical | NOA 61 | 40 | 160 | 65 |
| Cylindrical | NOA 61 | 40 | 200 | 65 |
| Cylindrical | NOA 61 | 40 | 250 | 65 |
| Cylindrical | NOA 61 | 40 | 300 | 65 |
| Cylindrical | NOA 61 | 80 | 113 | 37 |
| Cylindrical | NOA 61 | 80 | 113 | 65 |
| Cylindrical | NOA 61 | 80 | 160 | 37 |
| Cylindrical | NOA 61 | 80 | 160 | 65 |
| Cylindrical | NOA 61 | 80 | 240 | 37 |
| Cylindrical | NOA 61 | 80 | 240 | 65 |
| Cylindrical | Polycarbonate | 40 | 120 | 55 |

### Example 3

Articles comprising a plurality of hollow cylindrical or cross protrusions were prepared by the method described in Example 2, except that a PDMS stamp having a patterned surface that comprised a plurality of cylindrical indentations therein was contacted with the coated glass surface. The dimensions of the patterns of protrusions are summarized in the following Table.

TABLE
Patterns of hollow cylindrical-, cross-, and tiered cylindrical
ziggurat-shaped protrusions of the present invention prepared
by the method of Example 2. In all cases the protrusions
were formed on glass substrates.

| | Protrusion | | | |
|---|---|---|---|---|
| Shape | Material | Width (μm) | Pitch (μm) | Height (μm) |
| Hollow Cylindrical | NOA 61 | 40 | 57 | 37 |
| Hollow Cylindrical | NOA 61 | 40 | 57 | 65 |
| Hollow Cylindrical | NOA 61 | 40 | 80 | 37 |
| Hollow Cylindrical | NOA 61 | 40 | 80 | 65 |
| Hollow Cylindrical | NOA 61 | 40 | 120 | 37 |
| Hollow Cylindrical | NOA 61 | 40 | 120 | 65 |
| Hollow Cylindrical | NOA 61 | 40 | 175 | 37 |
| Hollow Cylindrical | NOA 61 | 40 | 175 | 65 |
| Cross | NOA 61 | 25, 100* | 242 | 37 |
| Cross | NOA 61 | 25, 100* | 242 | 65 |
| Cross | NOA 61 | 25, 100* | 550 | 37 |
| Cross | NOA 61 | 25, 100* | 550 | 65 |
| Cross | NOA 61 | 25, 242* | 550 | 37 |
| Cross | NOA 61 | 25, 242* | 550 | 65 |
| Tiered Cylindrical | NOA 61 | 80, 60, 40^{†} | 200 | 85 |
| Tiered Cylindrical | NOA 61 | 40, 30, 25^{†} | 120 | 85 |

*The width of the protruding crosses includes two dimensions, the first dimension is the cross-sectional width of the arm portion of the crosses and the second dimension is the arm-to-arm length of the cross (see FIG. 4A).
^{†}The tiered cylindrical protrusions comprise include three dimensions, the first of which is the diameter of the first (lowest) tier, the second of which is the diameter of the middle tier, and the third of which is the diameter of the third (highest) tier. The sidewalls of the tiered cylindrical protrusions were substantially orthogonal to the surface.

### Example 4

Articles comprising a plurality of parallel lines (as in a grating) were prepared by the method described in Example 1, except that a PDMS stamp having a patterned surface that comprised a plurality of parallel linear indentations therein was contacted with the coated glass surfaces. The dimensions of the resulting gratings are summarized in the following Table

TABLE
Gratings prepared by the method of Example 4.
In all cases the gratings were formed on glass substrates.

| Shape | Grating Material | Width (μm) | Pitch (μm) | Height (μm) |
|---|---|---|---|---|
| Rectilinear | NOA 61 | 10 | 115 | 10 |
| Rectilinear | NOA 61 | 25 | 32 | 10 |
| Rectilinear | NOA 61 | 25 | 64 | 10 |
| Rectilinear | NOA 61 | 25 | 64 | 37 |
| Rectilinear | NOA 61 | 25 | 64 | 65 |
| Rectilinear | NOA 61 | 25 | 127 | 10 |
| Rectilinear | NOA 61 | 25 | 127 | 37 |
| Rectilinear | NOA 61 | 25 | 127 | 58 |
| Rectilinear | NOA 61 | 25 | 127 | 65 |
| Rectilinear | NOA 61 | 25 | 280 | 10 |
| Rectilinear | NOA 61 | 25 | 280 | 37 |
| Rectilinear | NOA 61 | 25 | 280 | 58 |
| Rectilinear | NOA 61 | 25 | 280 | 65 |
| Rectilinear | NOA 61 | 25 | 650 | 10 |
| Rectilinear | NOA 61 | 25 | 650 | 37 |
| Rectilinear | NOA 61 | 25 | 650 | 58 |
| Rectilinear | NOA 61 | 25 | 650 | 65 |
| Rectilinear | NOA 61 | 40 | 120 | 37 |
| Rectilinear | NOA 61 | 40 | 120 | 65 |
| Rectilinear | NOA 61 | 40 | 200 | 37 |
| Rectilinear | NOA 61 | 40 | 200 | 65 |
| Rectilinear | NOA 61 | 40 | 450 | 10 |
| Rectilinear | NOA 61 | 40 | 450 | 37 |
| Rectilinear | NOA 61 | 40 | 450 | 58 |
| Rectilinear | NOA 61 | 40 | 450 | 65 |
| Rectilinear | NOA 61 | 78 | 200 | 37 |
| Rectilinear | NOA 61 | 78 | 200 | 65 |
| Rectilinear | NOA 61 | 100 | 500 | 37 |
| Rectilinear | NOA 61 | 100 | 500 | 65 |

### Example 5

A hydrophobic coating layer (TEFLON® AF-1600, from E.I. DuPont de Nemours Corp., Wilmington, Del.), was applied to the articles prepared in Example 1. The coatings were applied by first diluting the TEFLON® AF-1600 1:3 (by volume) in Fluorinert FC-40, followed by spin-casting the resulting solution onto a rotating substrate (2,500 rpm) for about 30 seconds. The coated articles were then baked in air at 90° C. for about 12 hours. The resulting articles comprised a hydrophobic conformal coating layer having a thickness of about 0.1 μm.

### Example 6

A hard-coat layer comprising a methylsilsesquioxane resin (HardSil™ AM, from Gelest Inc., Morrisville, Pa.) was applied to articles having polycarbonate grids or protrusions thereon, as prepared in Examples 1 and 2. The hard-coat layer was applied by dipping the articles into a solution of the hard-coat precursor solution (comprising 10-30% methanol, 30-60% isopropanol, and 10-30% n-butanol). After dip-coating, the articles were baked in air at 140° C. for about 1 hour. The resulting articles comprised an abrasion-resistant conformal coating layer having a thickness of about 5 μm.

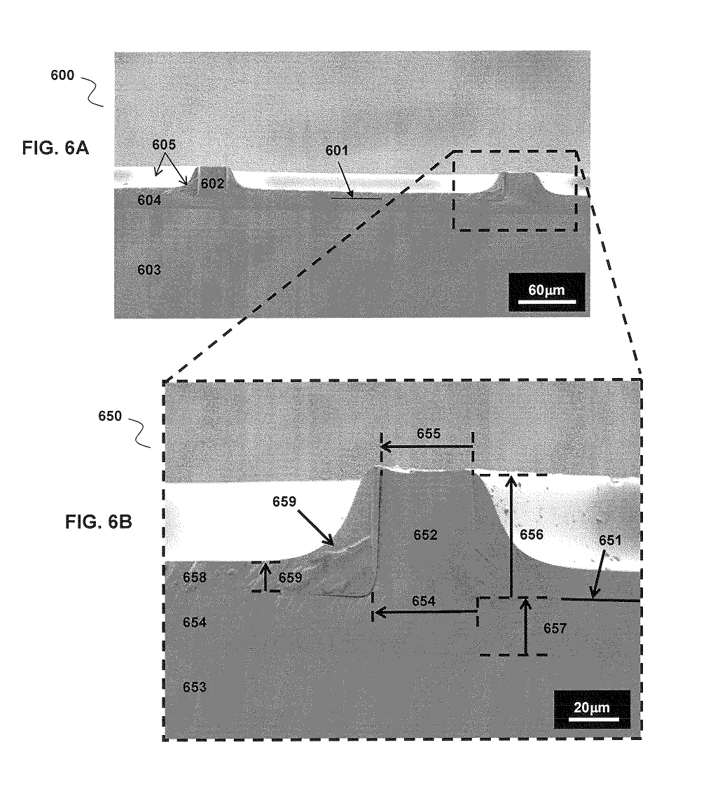

FIGS. 6A-6B provide cross-sectional scanning electron microscope (“SEM”) images of a hexagonal grid having a hard-coat layer thereon. Referring to FIG. 6A, SEM image 600 includes a cross-section of an article of the present invention comprising a front surface, 601, having a grid, 602, protruding therefrom. The article includes a glass under layer, 603, UV-curable composition (ST-3080, available BJB Enterprises, Inc., Tustin, Calif.), from which the grid, 602, is formed, and which is also present as a thin layer, 604, coating the glass surface and foaming the front surface, 601, of the article. Both the grid, 602, and front surface of the article, 601, have a hard-coat layer thereon, 605.

Referring to FIG. 6B, a high-resolution cross-sectional SEM of a portion of FIG. 6A is provided. The SEM image, 650, includes a cross-section of the glass, 653, the grid, 652, protruding from the front surface, 651, and the hard-coat layer, 658, which covers both the grid and the front surface of the article. The grid has a lateral dimension at the surface of the article (i.e., at the base of the grid) indicated by the magnitude of vector 654, and a lateral dimension at the outer surface of the grid indicated by the magnitude of vector 655. The grid also has a height indicated by the magnitude of vector 656. The material from which grid is formed also covers the glass at a thickness indicated by the magnitude of vector 657. The hard-coat layer, 658, coats the outer surface of the grid with a thin layer that is about 100-300 nm thick, and coats the front surface of the article at a thickness indicated by the magnitude of vector 659. Where the grid joins the front surface of the article, the hard-coat layer forms a meniscus, 659.

### Example 7

### Smudge Resistance Testing

The smudge resistance of the articles prepared in Examples 1-6 was examined by qualitative testing using the following protocol. First, a fingertip and thumb were cleaned on a dry, lint-free cloth. Second, the fingertip was wiped across the face (e.g., cheek) of the tester 4-6 times. Third, the tester rubbed the fingertip and thumb together for several second. Fourth, the finger was placed into contact with an article using a pressure of about 4-6 psi (measured using a scale), and the degree of smudging was then observed. The degree of smudging was evaluated qualitatively, and the results varied between: (1) no fingerprint observed on a surface; (2) a barely visible or speckled fingerprint observed on a surface; (3) a light fingerprint observed on a surface; and (4) a highly visible fingerprint observed on a surface (comparable to that left on a clean glass slide). Between each smudge test on an article of the present invention, the procedure was performed on a clean glass slide as a control.

The results showed that articles comprising hexagonal grids having a height of about 30 μm or greater provided better resistance to smudging compared with articles comprising grids having a height less than 30 μm. In addition, articles comprising hexagonal grids having a spacing or periodicity greater than about 300 μm to about 600 μm provided better resistance to smudging compared with articles comprising grids or protrusions having a spacing of less than 300 μm or greater than 600 μm.

The results also showed that articles comprising a plurality of cylindrical protrusions (i.e., posts) having a height of about 40 μm or greater, a diameter of about 50 μm to about 100 μm, and a pitch of about 80 μm to about 150 μm provided the best resistance to smudging.

### Example 8

### Abrasion Testing

The moderate and severe abrasion resistance of the articles prepared in Examples 1-6 was examined according to the requirements outlined in MIL-C-675 (Military Specification Coating of Glass Optical Elements (Anti-Reflection), Aug. 22, 1980), which is incorporated herein by reference. After testing, the articles were cleaned, dried, and inspected by eye for evidence of physical damage. Abrasion resistance was rated qualitatively as follows: (1) no structural damage of the grid or protrusions and no scratching of the article surfaces; (2) little to no structural damage of the grid or protrusions, but some scratching of article surfaces; and (3) structural damage of the grid or protrusions and scratching of the article surfaces. Structural damage of the grid or protrusions was detected by optical microscopy, and scratching of the article surface was determined using the naked eye.

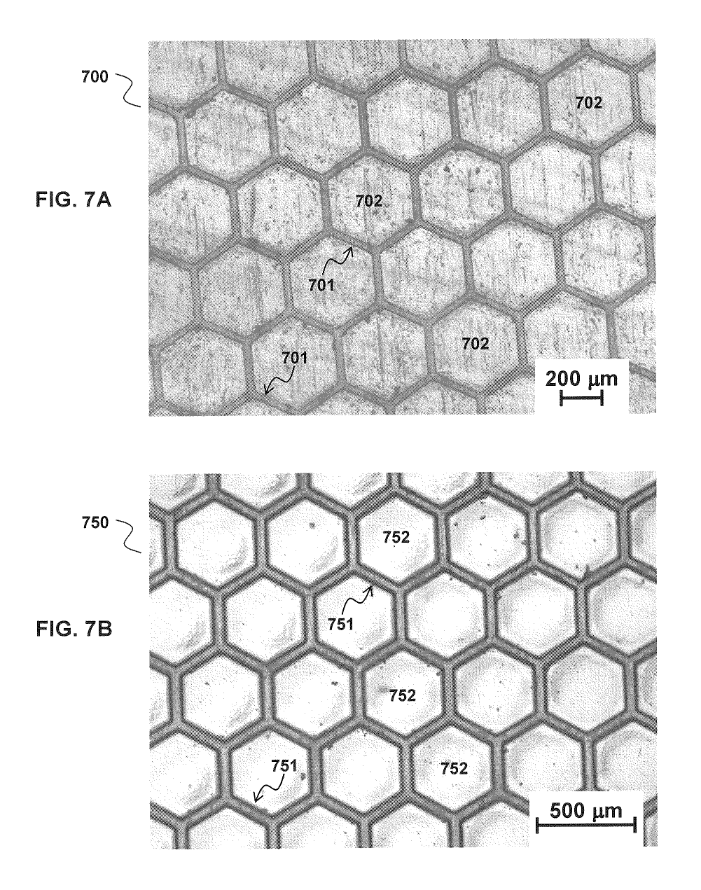

FIGS. 7A-7B provide optical microscopy images, 700 and 750, respectively, of articles of the present invention comprising protruding hexagonal grids after abrasion testing. The grids in FIGS. 7A-7B have a width of about 45 mm, a spacing of about 464 nm, and a height of about 38 nm. Referring to FIG. 7A, the article without a hard-coat applied thereto exhibited visible scratching on the front surface of the article, 702, as well as on the top surface of the grid, 701.

Referring to FIG. 7B, the article having a hard-coat applied thereto exhibited no visible scratching on the front surface of the article, 752, and only moderate abrasion on the top surface of the grid, 751.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. An article comprising front and back surfaces, the front surface comprising a plurality of protrusions extending from about 40% or less of the front surface of the article, the protrusions having a lateral dimension of about 40 μm to about 150 μm, a height of about 25 μm to about 300 μm, and a spacing of about 50 μm to about 600 μm, wherein 70% or more of light normally incident to the back surface of the article having a wavelength of 400 nm to 750 nm is transmitted through the article, and wherein 80% or more of the transmitted light is refracted by about 10° or less.

2. The article of claim 1, wherein the front surface comprises a plurality of protrusions extending from about 20% or less of the front surface of the article, the protrusions having a lateral dimension greater than 50 μm to about 150 μm, a height of about 25 μm to about 300 μm, and a spacing of about 50 μm to about 300 μm.

3. The article of claim 1 or 2, wherein the plurality of protrusions have a three-dimensional shape selected from: a cylinder, a trigonal post, a rectilinear post, a pentagonal post, a hexagonal post, an octagonal post, a trigonal pyramid, a square pyramid, a cone, a spike, a cross, a hollow variant thereof, and combinations thereof.

4. The article of any of claims 1-3, wherein the plurality of protrusions form a grid.

5. The article of claim 4, wherein the grid is a polygonal grid.

6. The article of claim 5, wherein the polygonal grid comprises at least one polygon selecting from: triangles, squares, pentagons, hexagons, heptagons, octagons, and the like, and combinations thereof.

7. The article of claim 6, wherein the polygons are irregular.

8. The articles of any of claims 5-7, wherein the polygons are arranged randomly.

9. The article of claim 4, wherein the grid is a hexagonal grid.

10. The article of claim 9, wherein the hexagonal grid has a height of about 50 μm to about 65 μm, a lateral dimension of about 40 μm to about 60 μm, and a spacing of about 400 μm to about 600 μm.

11. The article of any of claims 1-10, wherein the plurality of protrusions form posts.

12. The article of claim 11, wherein the posts have a height of about 50 μm to about 65 μm, a lateral dimension of about 40 μm to about 60 μm, and a spacing of about 100 μm to about 200 μm.

13. The article of any of claims 1-12, wherein the plurality of protrusions have sidewalls that are smooth, angled, beveled, corrugated, tiered, roughened, or a combination thereof.

14. The article of any of claims 1-13, wherein at least an outer surface of the plurality of protrusions have a surface free energy of about 50 mN/m or less.

15. The article of any of claims 1-14, further comprising a coating on at least a portion of the plurality of protrusions.

16. The article of claim 15, wherein the coating is an anti-reflective coating that is present on at least a portion of the plurality of protrusions, and optionally present on the front surface of the article, the anti-reflective coating comprising a bottom layer and a top layer, each layer having a transmission of about 90% or higher at a wavelength of 400 nm to 800 nm, wherein the bottom layer has a first refractive index and the top layer has a refractive index that is about 10% to about 90% less than the refractive index of the bottom layer, and one or more gradient layers are optionally present between the bottom layer and the top layer, wherein each optional gradient layer has a refractive index that is at least 10% less than a refractive index of an immediate underlying layer.

17. The article of claim 15, wherein the coating is an anti-reflective coating that is present on at least a portion of the plurality of protrusions, and optionally present on the front surface of the article, the anti-reflective coating comprising a plurality of layers, each layer having a transmission of about 90% or higher at a wavelength of 400 nm to 800 nm, and each layer having a thickness of about 100 nm to about 200 nm, wherein adjacent layers in the anti-reflective coating differ in refractive index by about 10% or more.

18. The article of claim 15, wherein the coating is an anti-reflective coating that is present on at least a portion of the plurality of protrusions, and optionally present on the front surface of the article, the anti-reflective coating comprising a plurality of nanoscale protrusions extending from the surface, wherein the nanoscale protrusions include a pointed end portion and have a height of about 100 nm to about 5,000 nm and a lateral dimension of about 100 nm to about 3,000 nm.

19. The article of any of claims 1-18, wherein the front surface of the article is substantially smooth.

20. The article of any of claims 1-19, wherein the front surface of the article is roughened.

21. The article of any of claims 1-20, wherein 80% or more of light normally incident to the back surface of the article having a wavelength of 400 nm to 750 nm is transmitted through the article.

22. The article of any of claims 1-21, wherein the article comprises a material selected from: quartz, alumina, aluminum oxynitride, magnesium aluminate spinel, silica, borosilicate glass, indium tin oxide, a polycarbonate, high-density polyethylene, a nylon, a polyurethane, a polyacrylate, a poly(alkyl methacrylate), a polyethylene terephthalate, a composite thereof, and combinations thereof.

23. A product comprising the article of any of claims 1-22.

24. The product of claim 23, wherein the product is selected from: a window, a display device, a communications device, a photograph, and a lens.

25. The product of claim 24, wherein the product is a display device having the article applied to an outer surface, and the display device transmits light normally incident to the back surface of the substrate.
